(19) United States
(12) Patent Application Publication
(10) Pub. No.: US 2010/0281268 A1
(43) Pub. Date: Nov. 4, 2010

(54) Personalizing an Adaptive Input Device

(75) Inventors: Charlton Barreto, Seattle, WA (US); Robert D. Young, Kirkland, WA (US); Stephen Cooper, Seattle, WA (US); Jason Bluming, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/433,813

(22) Filed: Apr. 30, 2009

(51) Int. Cl. G06F 21/00; G06F 7/06; H04L 9/32; G06F 17/30; G06F 3/02

(52) U.S. Cl. 713/182; 726/21; 345/168; 707/E17.014; 707/E17.032

(57) ABSTRACT

Methods and systems for personalizing an adaptive input device having a dynamically updateable display region are provided herein. One exemplary method includes sending an identity data query from a server to a computing device operatively coupled to an adaptive input device. The method further includes receiving identity data at the server from the computing device. The identity data includes one or more of a user identifier, a role identifier, a device identifier and a content identifier. The method further includes retrieving profile data from a profile storage module of the server, the profile data being based on the identity data, and the profile data including one or more of device-specific settings, application-specific settings, and user-specific settings for the adaptive input device. The method further includes sending the profile data to the computing device to update the visual appearance of the display region.

### BACKGROUND

Adaptive input devices include input devices that can change their appearance based on an operating context. One example of an adaptive input device is a touch screen. Touch screens and other adaptive input devices for computers have become increasingly popular for their data input flexibility. This flexibility enables a user to set a personalized configuration for the touch screen, which may uniquely suit a user in a particular operating environment.

However, one drawback with making such a personalized configuration for a touch screen is that the personalized configuration is difficult to transfer to a second adaptive input device, especially when a first and second touch screen are different types. Users of multiple touch screens are forced to laboriously configure each touch screen separately, which can be time-consuming and tiresome. The user may be forced to remember numerous settings that were inputted in the distant past. Further, the manner of making the settings may differ from device to device, further complicating the task. As a result a user may erroneously input personalized configuration settings for a second adaptive input device, or may give up on personalizing the second adaptive input device entirely.

### SUMMARY

Methods and systems for personalizing an adaptive input device having a dynamically updateable display region are provided herein. One exemplary method includes sending an identity data query from a server to a computing device operatively coupled to an adaptive input device. The method further includes receiving identity data at the server from the computing device. The identity data includes one or more of a user identifier, a role identifier, a device identifier and a content identifier. The method further includes retrieving profile data from a profile storage module of the server, the profile data being based on the identity data, and the profile data including one or more of device-specific settings, application-specific settings, and user-specific settings for the adaptive input device. The method further includes sending the profile data to the computing device to update the visual appearance of the display region.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates a computing system including an adaptive input device in accordance with an embodiment of the present disclosure.

FIG. 1B illustrates dynamic updates to the visual appearance of the adaptive input device of FIG. 1A.

FIG. 1C illustrates dynamic updates to the visual appearance of a touch screen user input device.

FIG. 2 is a schematic view of a system for personalizing an adaptive input device.

FIG. 3 is a flowchart illustrating an exemplary method for personalizing an adaptive input device.

### DETAILED DESCRIPTION

The present disclosure is related to an adaptive input device that can provide input to a variety of different computing systems. The adaptive input device may include one or more physical or virtual controls that a user can activate to effectuate a desired user input. The adaptive input device is capable of dynamically changing its visual appearance to facilitate user input. As an example, the adaptive input device may dynamically change the appearance of one or more depressible buttons (e.g., keys of a keyboard). The visual appearance of the adaptive input device may be dynamically changed according to user-specific settings (e.g., user preferences), application scenarios, system scenarios, etc., as described in more detail below.

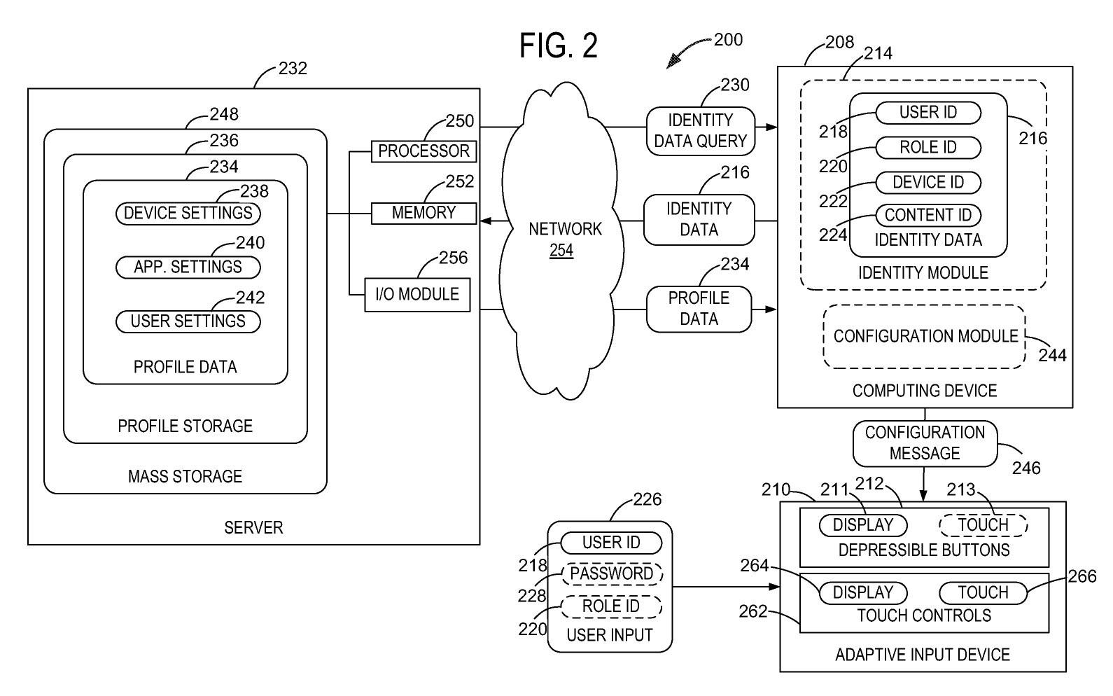

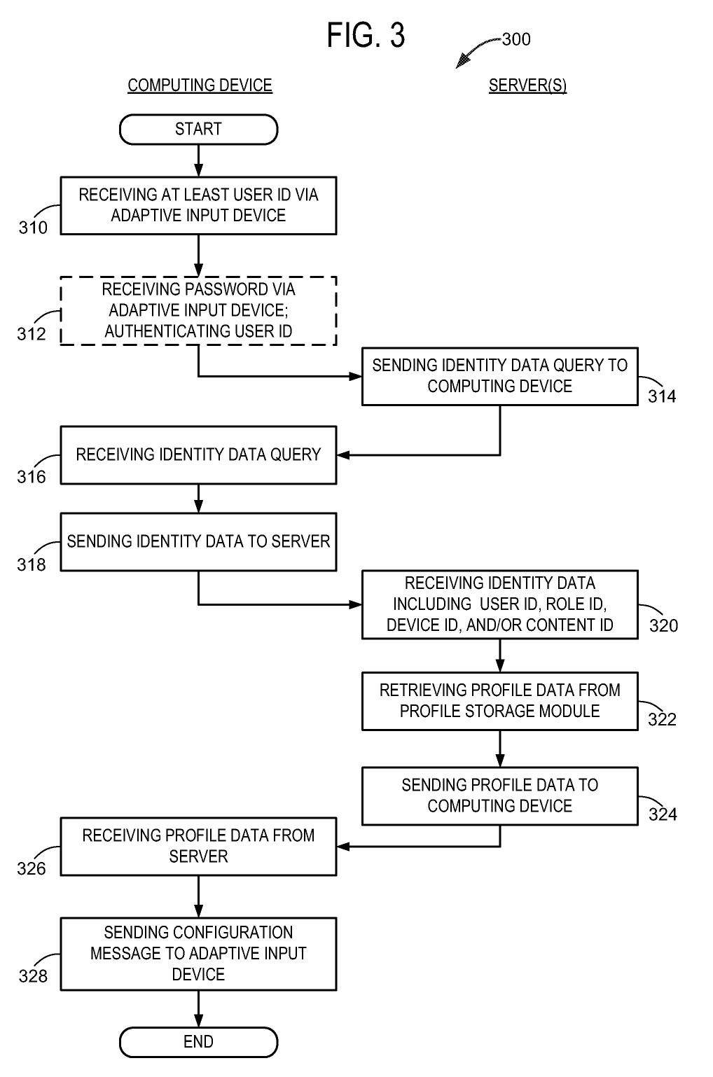

As explained with reference to FIGS. 2 and 3 herein, an adaptive input device may be configured to interoperate with a server to acquire profile data for personalizing the adaptive input device. In particular, profile data related to a user, a desired role (e.g., “at home”, “at work”, “traveling”, “gaming”, etc.), and the adaptive input device in use, may be received from the server at a computing device operatively coupled to the adaptive input device in order to configure the visual appearance and/or functionality of the adaptive input device with personalized settings.

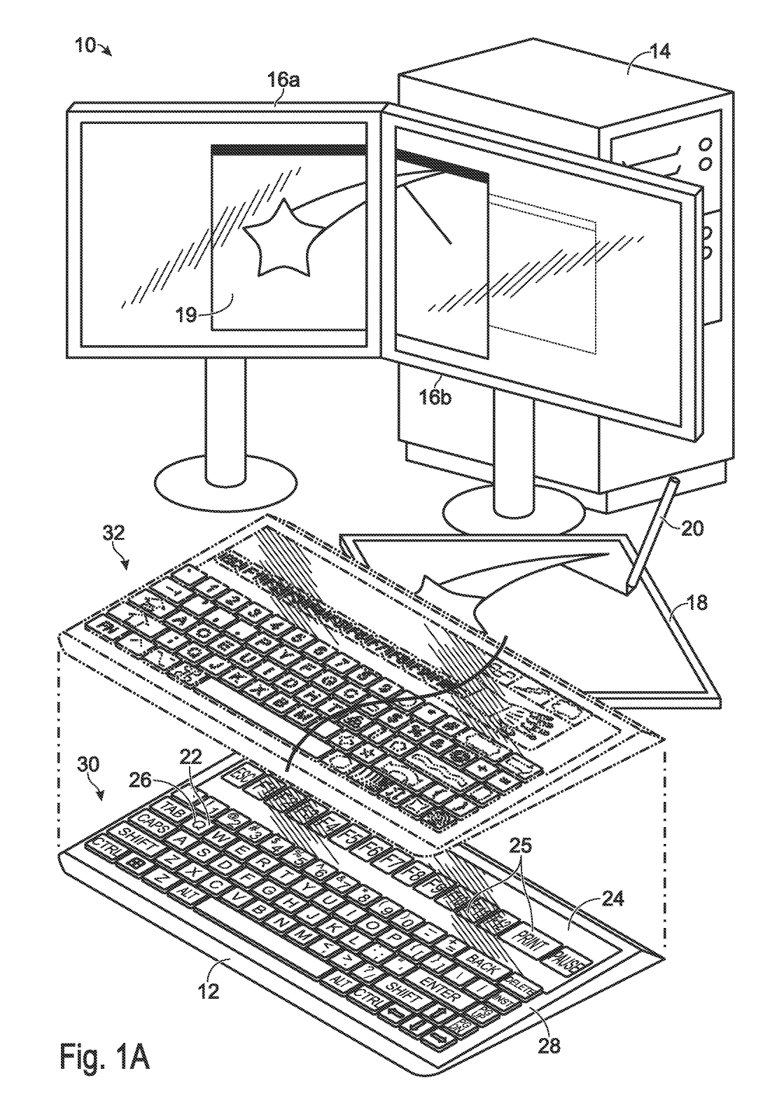

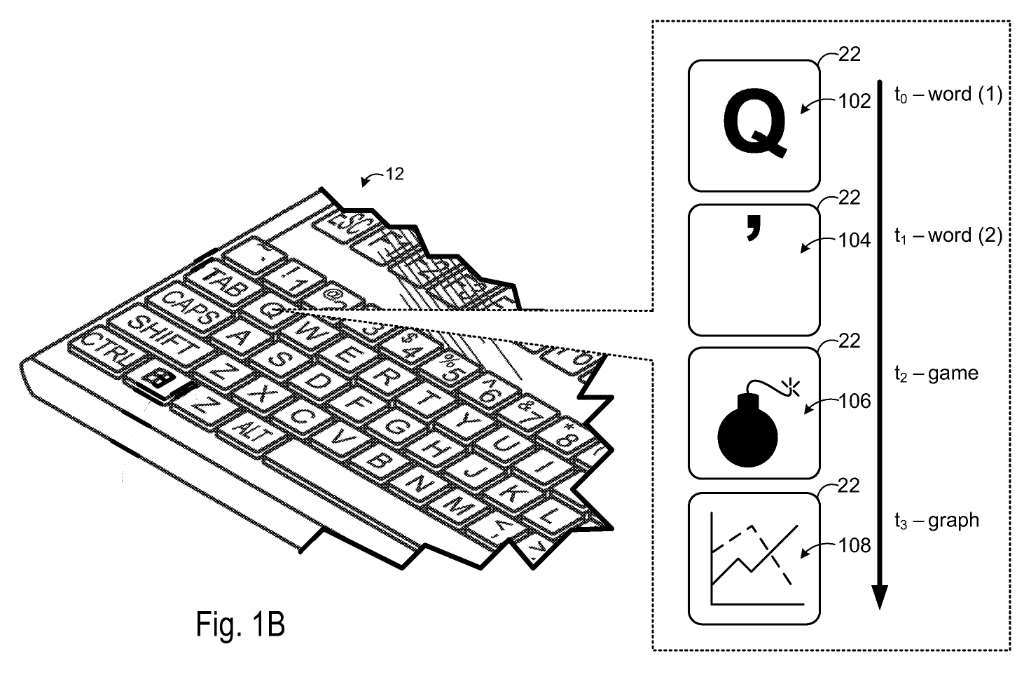

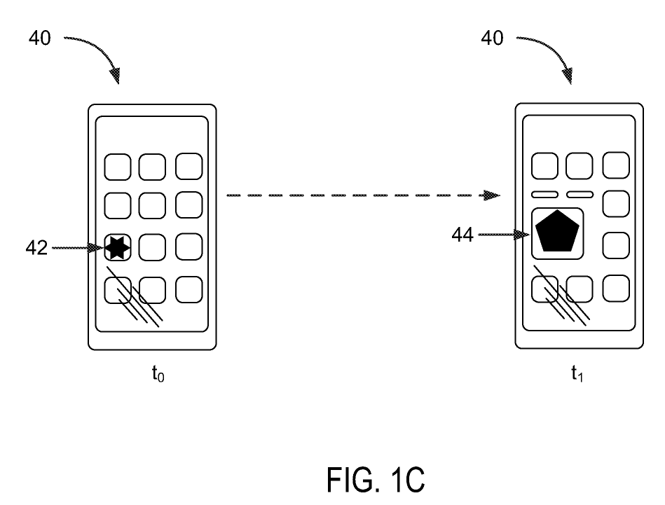

FIG. 1A shows an embodiment of a computing system 10 including an adaptive input device 12, such as an adaptive keyboard or adaptive touch screen, with a dynamically changing appearance. The adaptive input device 12 is shown connected to a computing device 14. The computing device 14 may be configured to process input received from adaptive input device 12. The computing device 14 may also be configured to dynamically change an appearance of the adaptive input device 12.

Computing system 10 may further include a monitor, such as monitor 16a and monitor 16b. While computing system 10 is shown including two monitors, it is to be understood that computing systems including fewer or more monitors are within the scope of this disclosure. The monitor(s) may be used to visually present visual information to a user, via an active desktop managed by an operating system of the computing device.

Computing system 10 may further include a peripheral input device 18 configured to receive input via a stylus 20. Computing device 14 may process an input received from the peripheral input device 18 and display a corresponding visual output 19 on the monitor(s) via the active desktop, while the input received from the peripheral input device 18 may not affect the appearance of the adaptive input device 12, which may be managed by a hidden desktop. While a drawing tablet is shown as an exemplary peripheral input device, it is to be understood that the present disclosure is compatible with virtually any type of peripheral input device (e.g., keyboard, number pad, mouse, track pad, trackball, touch pad, etc.).

In the illustrated embodiment, adaptive input device 12 includes a plurality of depressible buttons, such as depressible button 22, and touch controls, such as touch control 24. The adaptive input device may be configured to recognize when a button is pressed or otherwise actuated. The adaptive input device may also be configured to recognize touch input directed to a portion of touch control 24. In this way, the adaptive input device may recognize user input. Touch input may be detectable, for example, by electrical sensors, such as a capacitive sensor, and/or optical sensors, such as infrared cameras. In some embodiments, one or more depressible buttons may also be configured to recognize user input via touch input at one or more touch-sensitive input regions of the depressible button.

Depressible buttons and touch controls may have dynamically changeable, or updateable, visual appearances. In particular, a button image 26 may be presented on a button, and such a button image may be adaptively updated. A button image may be changed to visually signal a changing functionality of the button, for example. Furthermore, the computing device 14 may display an image across more than one buttons.

Similarly, the touch control 24 may have a dynamically changeable visual appearance. In particular, various types of touch images 25 may be presented by the touch control, and such touch images 25 may be adaptively updated. As an example, the touch control 24 may be used to visually present one or more different touch images 25 that serve as virtual controls (e.g., virtual buttons, virtual dials, virtual sliders, etc.), each of which may be activated responsive to a touch input directed to that touch image. The number, size, shape, color, and/or other aspects of the touch images 25 can be changed to visually signal changing functionality of the touch controls.

The adaptive input device may also present a background image 28 in an area that is not occupied by button images or touch images. The visual appearance of the background image 28 also may be dynamically updated. The visual appearance of the background may be set to create a desired contrast with the button images and/or the touch images, to create a desired ambiance, to signal a mode of operation, or for virtually any other purpose.

By adjusting one or more of the button images (e.g., button image 26), the touch images 25, and/or the background image 28, the visual appearance of the adaptive input device 12 may be dynamically adjusted and customized. As an example, FIG. 1A shows adaptive input device 12 with a first visual appearance 30 in solid lines, and an example second visual appearance 32 of adaptive input device 12 in dashed lines.

The visual appearance of different regions of the adaptive input device 12, as well as input methods and input modalities of the adaptive input device 12 may be customized based on a large variety of parameters. As further elaborated with reference to FIG. 1B, these may include: active applications, application context, system context, application state changes, system state changes, user settings, application settings, system settings, context changes, network-based events, user identity, user role, gesture inputs received at the adaptive input device 12, etc.

In one example, if a user selects a word processing application, the button images may be automatically updated to display a familiar QWERTY keyboard layout. Button images also may be automatically updated with icons, menu items, etc. from the selected application. For example, when using a word processing application, one or more button images may be used to present frequently used word processing operations such as “cut,” “paste,” “underline,” “bold,” etc. Furthermore, the touch control 24 may be automatically updated to display touch images 25 for virtual controls tailored to controlling the word processing application.

As an example, at t₀, FIG. 1B shows depressible button 22 of adaptive input device 12 visually presenting a Q-image 102 of a QWERTY keyboard. At t₁, FIG. 1B shows the depressible button 22 after it has dynamically changed to visually present an apostrophe image 104 of a Dvorak keyboard in the same position that Q-image 102 was previously displayed.

In another example, if a user selects a gaming application, the depressible buttons and/or touch control may be automatically updated to display frequently used gaming controls. For example, at t₂, FIG. 1B shows depressible button 22 after it has dynamically changed to visually present a bomb image 106. As still another example, if a user selects a graphing application, the depressible buttons and/or touch control may be automatically updated to display frequently used graphing controls. For example, at t₃, FIG. 1B shows depressible button 22 after it has dynamically changed to visually present a line-plot image 108.

As illustrated in FIG. 1B, the adaptive input device 12 dynamically changes to offer the user input options relevant to the task at hand. The entirety of the adaptive input device may be dynamically updated, and/or any subset of the adaptive input device may be dynamically updated. In other words, all of the depressible buttons may be updated concurrently, each button may be updated independent of other depressible buttons, or any configuration in between.

In an alternate embodiment, an adaptive input device may include touch controls and no depressible keys, such as a touch screen user input device 40 (e.g., a handheld computing device) shown in FIG. 1C. The touch screen user input device 40 may be configured with a keyboard display and a touch sensor configured to detect touch input from a user. In this example, a virtual keyboard is displayed on the touch screen user input device 40. The virtual keyboard may include keys of various sizes and shapes that are displayed on the touch screen user input device 40, as illustrated. For example, at t₀, a star image is displayed as a touch image on a touch control 42. Responsive to a change in user-specific settings at t₁, for example, the keyboard may show a touch control 44 formed in a different size and shape, and with a different touch image, namely a pentagon, depicted thereon.

It may be appreciated that a user may customize the visual appearance of an adaptive input device based on user-specific settings. For example, the user may adjust which button images and/or touch images are presented in different scenarios.

Turning now to FIG. 2, a schematic view of a system 200 for personalizing an adaptive input device 210 is illustrated. The adaptive input device 210 may include a plurality of depressible buttons 212, and one or more depressible buttons may each have a display region 211 configured to display graphical images. Furthermore, one or more depressible buttons may include a touch-sensitive input region 213 (e.g., a region including touch sensor) for detecting touch input.

The adaptive input device 210 may also include a plurality of non-depressible touch controls 262, where one or more touch controls 262 may each include a display region 264 and a touch-sensitive input region 266. The display regions and/or touch-sensitive input regions of the non-depressible touch controls 262 may be understood to operate similarly to the display regions and/or touch-sensitive input regions of the depressible buttons as described herein. That is, display regions may be dynamically updateable to change the visual appearance of the display region and touch-sensitive input regions may be sensitive to touch input.

The system 200 includes a computing device 208 operatively coupled to the adaptive input device 210. The use of “operatively coupled” herein may include coupling via a wired configuration, or a wireless configuration as in some examples. The computing device 208 may have an identity module 214 containing identity data 216 identifying a user of the computing device (e.g., user identifier 218), a desired role of the user (e.g., role identifier 220), the type of adaptive input device (e.g., device identifier 222), and components and/or capabilities of the computing device 208 interoperable with the adaptive input device 210 (e.g., content identifier 224).

The identity module 214 of the computing device 208 may be configured to receive the user identifier 218 via user input 226 at the adaptive input device 210. The user identifier 218 may include, or be related to, a user name used by a user to login to a user-created account. As will be discussed later, it is desirable for the computing device 208 to have knowledge of the user identifier so that the adaptive input device 210 can be configured according to the associated user's preferences. Furthermore, the computing device 208 may include code to receive an authentication or authorization identifier, such as a password 228 via the adaptive input device 210, and to authenticate the user identifier 218 based on the password 228.

The role identifier 220 may also be received at the identity module 214 via user input 226 received from the adaptive input device 210, and included in the identity data 216 at the computing device 208. In such a case, the user input 226 may specify a role (e.g., at home, at work, travelling, gaming, communications, media editing, etc.) the user wishes to employ with respect to the configuration of the user's current adaptive input device. In another case, the role identifier 220 may be automatically updated and/or retrieved based on the geographic location of the adaptive input device 210. For example, a global positioning system, or other localizing technique or system, may detect the location of an adaptive input device 210 and send a role identifier, based on the detected location, to the computing device 208. In this way, a role identifier may be associated with a particular location, and/or a geographic location may be associated with a role identifier. Thus, a first adaptive keyboard device may be identified as having a “home” role identifier when the adaptive input device 210 is located at a user's home address, and the same adaptive input device 210 may be associated with the “travelling” role identifier when it is located at an airport or on a train, as some examples. Further, it may be appreciated that each user identifier and each device identifier may be associated with one or more role identifiers, enabling a particular user or adaptive input device to be identified with a particular role.

Accordingly, the identity data 216 includes the device identifier 222 indicating an adaptive input device type, such as the make, model and/or version of a particular adaptive input device. The device identifier 222 may also be associated with a location and/or a role identifier, if a particular device is consistently used in a particular location or in conjunction with a particular role identifier.

The identity data 216 also includes the content identifier 224 indicating one or more components of the computing device 208 accessible to, or interoperable with, the adaptive input device 210. For a first user identifier, first role identifier, and first device identifier (e.g., a “home computer”), a first content identifier may indicate that audio content, video content, and photographic content are interoperable with the adaptive input device. That is, aspects of the respective content can be representatively displayed on display regions of an adaptive input device, and/or aspects of the respective content can be functionally associated with depressible buttons of the adaptive input device 210. In contrast, for the first user identifier, first role identifier, and a second device identifier (e.g., a “work computer”), a content identifier may indicate that the content interoperable with the adaptive input device includes a documents folder, an email account, and a personal schedule, for example.

Also, the content identifier indicating the documents folder, email account, and personal schedule may be available for a second user identifier, second role identifier, and the first device identifier (e.g., “home computer”), and so on. Thus, it may be appreciated that each content identifier can be associated with one or more device identifiers, user identifiers, and/or role identifiers. Content identifiers may also indicate that a particular component is to be enabled upon detection of the component by the computing device.

As may be appreciated by the description herein, any change to one of the identifiers of the identity data 216 (e.g., user identifier 218, role identifier 220, device identifier 222, content identifier 224, etc.) may trigger a change in another identifier of the identity data 216. For example, when a user identifier is changed, it may trigger a change of role identifier and content identifier, and may not trigger a change of device identifier. However, a change to a content identifier, for example, may not trigger a change to any of the other identifiers.

The identity module 214 of computing device 208 may receive an identity data query 230 at the computing device 208 from a server 232. The identity data query 230 may be a query to at least one library of the computing device 208. In one example, the queried libraries may be standard libraries of an adaptive input software client, or adaptive input service hosted on the computing device 208. In other examples, an identity data query may be a query to an identity authentication input device, an identity brokerage service, or any other input mechanism that is configured for authentication of an adaptive input device. Thus, the identity data query 230 may be recognized at the computing device 208 if the computing device 208 includes the adaptive input software client or adaptive input service configured to communicate with the server 232 in the ways described herein, or if the computing device is otherwise authenticated, for example, by a third party source. An adaptive input device may include a public/private key pair, password, or another type of identity, authentication, or authorization technology in order to authenticate an adaptive input device to software and/or services on a computing device. Such a key pair, or password, may be input by a user and/or downloaded from an authentication server, as some examples, in order to authenticate the device.

For exemplary system 200, it may be assumed that any software clients for recognizing identity data queries, for sending identity data and receiving profile data, as will be described, are installed. Thus, in the exemplary system 200, the identity module 214 may send the identity data 216 (including the user identifier 218, role identifier 220, device identifier 222 and content identifier 224) to the server 232 responsive to the receipt of the identity data query 230.

When the server 232 receives the identity data 216, it may retrieve related profile data 234 from a profile storage module 236. That is, the profile data 234 is related to the identity data 216 received at the server 232. Each combination of identifiers in the identity data 216 may be associated with a distinct set of profile data 234 for configuration of adaptive input device 210. As another example, more than one combination of identifiers may be associated with a same set of profile data for configuration of the adaptive input device 210.

The profile data 234 may include device-specific settings 238, application-specific settings 240, and/or user-specific settings 242 for the configuration of the adaptive input device 210. For example, device-specific settings 238 may include a data transport protocol type (e.g., wired USB, wireless USB, BLUETOOTH, TCP/IP, etc.), data transport protocol capabilities (e.g., data throughput), graphics hardware capabilities, general processing capabilities, operating system type and/or the capabilities of the operating system. Application-specific settings 240 may include settings specified by applications (e.g., application programs) running on the computing device 208 during the use of the adaptive input device 210. For example, applications running and having access to the adaptive input device 210 may specify a desired layout and/or touch-sensitivity threshold of the adaptive input device 210 for a particular application. User-specific settings 242 may include, for example, an adaptive keyboard device theme or background image, RSS feeds to display on the adaptive input device 210, functional key remapping for accessibility, and other preferences specified by a user via user input 226.

The computing device 208 may accordingly include a configuration module 244 for receiving profile data 234 from the server 232. A configuration message 246 including instructions to change a visual appearance of one or more depressible buttons 212 and/or instructions to change a functionality of one or more depressible buttons 212 may be sent to the adaptive input device 210. More specifically, the configuration message 246 may be sent to change a visual appearance of one or more display regions and/or to change a functionality of one or more touch-sensitive input regions based on the profile data 234. The configuration message 246 may be sent responsive to the sending of profile data 234 to the computing device 208, or may be sent at predetermined time intervals so that the adaptive input device 210 receives configuration updates in the configuration message 246.

The server 232 described in this example may be a distributed network of a plurality of servers, collectively configured to operate as the described server 232. Similarly, the computing device 208 can be a distributed network of a plurality of computing devices, collectively configured to perform as the computing device 208.

It will be appreciated that the profile storage module 236, and/or some clients and various respective software components described above may be stored in a mass storage 248 and executed on a processor 250 using portions of memory 252 and may further be configured to communicate with software on other computing devices across one or more computer networks 254, via input/output module 256. It will further be appreciated that the server 232 may be a single server, or multiple distributed servers interoperating across one or more computer networks 254 (e.g., Local area network, Internet, etc.), and the components of profile storage module 236, and/or some clients may be implemented on these distributed devices. In alternate examples, several different computer networks may be used for transmission of identity data queries, identity data, and profile data, etc.

Turning now to FIG. 3, a flowchart illustrates an exemplary method 300 for personalizing an adaptive input device. Method steps illustrated in the left column can be understood to occur at a computing device, such as computing device 208 of FIG. 2, and method steps illustrated in the right column can be understood to occur at a server or plurality of servers, such as server 232 of FIG. 2.

At 310, the method 300 includes receiving at least a user identifier, and/or a role identifier, at a computing device via an adaptive input device. As described with respect to FIG. 2, a role identifier may be specified by user input alongside the user identifier via the adaptive input device, or the role identifier may be detected by an adaptive input device location.

The method may include, at 312 receiving a password via the adaptive input device, and authenticating the user identifier based on the password.

At 314, the method 300 includes sending an identity data query from a server to a computing device operatively coupled to an adaptive input device. The method 300 accordingly includes receiving the identity data query at the computing device from the server at 316, and sending identity data (including the user identifier) to the server from the computing device at 318, responsive to the identity data query.

Thus, at 320, the method 300 includes receiving identity data at the server from the computing device, the identity data including one or more of a user identifier, a role identifier, a device identifier and a content identifier as described above. Thus, the method 300 may include retrieving profile data from a profile storage module of the server at 322, the profile data being based on the identity data.

Profile data, as described with respect to the systems and methods described herein, may include one or more preferences (i.e. settings) included in one or more of the device-specific settings, application-specific settings, and/or user-specific settings for the adaptive input device. In some examples, a preference may be set as a device-specific setting or application-specific setting, an then may be re-set by a user to be an overriding user-specific setting, and vice versa.

One example of a preference is a peripheral device preference. Peripheral device preferences may include a camera preference indicating how to configure the adaptive keyboard layout based on a camera plug-in, and/or during camera use. Another type of peripheral device preference may be a display preference indicating how to configure an adaptive input device layout based on a display layout, and/or how to interoperate a display and adaptive input device.

Input method preferences are another example of preferences stored in profile data. Input method preferences may include gesture-detection thresholds, such as a technique for detecting gestures (e.g., touch-sensitive capacitive sensors, camera-based technique). Furthermore, input method preferences may include a proximity threshold, indicating the closeness of a gesture to the keyboard for detection. Further still, input method preferences may include specifications for computing functions associated with particular buttons or groups of buttons. A capacitive threshold for detecting a touch may also be included in the profile data, indicating the capacitive difference threshold between two points on the adaptive input device.

Other types of profile data may include a security preference, such as a time to adaptive input device inactivation threshold, and a sharing preference indicating whether other users can view profile data of a first user, and/or whether other users can use the profile data of a first user, etc. Further, profile data may include a performance preference, such as a graphical processing unit performance, a data throughput rate, and a preferred performance level. In one example, a user may select a performance level for a particular gaming software application to interact with an adaptive input device with “highest possible performance”, regardless of other software applications running on the computing device. In another example, the performance level for a gaming software application on an adaptive input device may be set to “auto throttle” (i.e. to automatically select) the performance level based on the computing power of the computing device and other software applications running on the computing device. Even further, profile data may include a scenario preference for one of a plurality of adaptive input device scenarios, a graphical layout preference (e.g., QWERTY keyboard, Dvorak keyboard, etc.), and a language preference (e.g., English, Spanish, etc.). It will be appreciated that the scenario preference may be for one of a plurality of predefined or user defined adaptive input device scenarios that are managed by an optimization tool for the hidden desktop of the adaptive input device. The scenarios may be workflow or location-based, for example. Examples of such scenarios include office worker, mobile worker, task worker, contract or offshore worker, and access from home. Each scenario has associated preferences that are used by the optimization tool to organize and specify the behavior of the hidden desktop.

Profile data may also include access to other user identifiers associated with a first user identifier. For example, receiving profile data at a computing device may include receiving other user identifiers associated with the first user identifier and other passwords for the other identifiers, such that a user may, for example, be allowed access to his/her email. In this way, information sources associated with the first user identifier can be leveraged with the systems and methods described herein to quickly and easily gain access to information sources, such as email, a user may desire access to. In one example, access to these other user identifiers associated with the first user identifier may be a user-specific setting, such that a user of the first user identifier may opt-in or opt-out of this setting.

Returning to FIG. 3, at 324, the method includes sending profile data to the computing device, and receiving the profile data at the computing device from the server at 326. Then, the method 300 may include sending a configuration message to the adaptive input device at 328, the configuration message being based on the profile data. As described above, the adaptive input device may have a plurality of depressible buttons, and one or more depressible buttons may include a display region configured to display graphical images and/or a touch-sensitive input region for detecting touch input. Accordingly, the configuration message may include instructions to change a visual appearance of one or more display regions of one or more depressible buttons and/or instructions to change a functionality of one or more depressible buttons. A functionality of a depressible button may include the touch-sensitivity of the depressible button and/or a computing function executable upon touch or depression of that depressible button.

It will be appreciated that the computing devices described herein may be any suitable computing device configured to execute the programs described herein. For example, the computing devices may be a mainframe computer, personal computer, laptop computer, portable data assistant (PDA), mobile internet device (MID), networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, markup languages, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for personalizing an adaptive input device having a dynamically updateable display region, the method comprising:
sending an identity data query from a server to a computing device operatively coupled to an adaptive input device;
receiving identity data at the server from the computing device, the identity data including one or more of a user identifier, a role identifier, a device identifier and a content identifier;
retrieving profile data from a profile storage module of the server, the profile data being based on the identity data, and the profile data including one or more of device-specific settings, application-specific settings, and user-specific settings for the adaptive input device; and
sending the profile data to the computing device to update the visual appearance of the display region.

2. The method of claim 1, where profile data includes one or more of peripheral device preferences and input method preferences.

3. The method of claim 1, where profile data includes one or more of a security preference, a sharing preference, a performance preference, a graphical layout preference, a scenario preference, and a language preference.

4. The method of claim 1, where device-specific settings include one or more of data transport protocol type and capabilities, graphics hardware capabilities, general processing capabilities, and operating system type and capabilities.

5. The method of claim 1, where the adaptive input device includes a plurality of depressible buttons, and one or more depressible buttons includes the display region for displaying images and/or a touch-sensitive input region for detecting touch input.

6. The method of claim 5, where a configuration message is sent to an adaptive input device to change one or more of a visual appearance of the display region, a functionality of the touch-sensitive input region, and an input modality of the adaptive input device, responsive to the sending of profile data to the computing device and based on the profile data.

7. The method of claim 1, where the identity data query is a query to one or more of a library of the computing device, an identity authentication input device, and an identity brokerage service.

8. The method of claim 1, where the server is a distributed network of servers.

9. A method for personalizing an adaptive input device including a dynamically updateable display region, the adaptive input device operatively coupled to a computing device, the method including:
receiving at least a user identifier at the computing device via the adaptive input device;
receiving an identity data query at the computing device from a server;
sending identity data including the user identifier to a server from the computing device, responsive to the identity data query;
receiving profile data related to the identity data from the server at the computing device, the profile data including one or more of device-specific settings, application-specific settings, and user-specific settings; and
sending a configuration message to the adaptive input device to update one or more of the visual appearance of the display region and an input modality of the adaptive input device, the configuration message being based on the profile data.

10. The method of claim 9, further comprising receiving a public or private key pair at the computing device, and authenticating the adaptive input device based on the key pair.

11. The method of claim 9, where identity data further includes a role identifier indicating a desired role, and where the user identifier is associated with one or more role identifiers.

12. The method of claim 11, where the role identifier is specified by user input via the adaptive input device and/or detected by an adaptive input device location.

13. The method of claim 11, where identity data further includes a device identifier indicating an adaptive input device type.

14. The method of claim 9, where identity data further includes a content identifier indicating one or more components and/or capabilities of the computing device accessible to the adaptive input device.

15. The method of claim 9, where the adaptive input device includes a plurality of depressible buttons, and where one or more depressible buttons includes the display region for displaying graphical images and/or a touch-sensitive input region for detecting touch input, where sending the configuration message to update an input modality includes updating a touch sensitivity of the touch-sensitive input region.

16. The method of claim 15, where the configuration message has instructions to configure the adaptive input device based on the profile data including instructions to change a visual appearance of the display region and/or instructions to change a functionality of one or more depressible buttons.

17. A system for personalizing an adaptive input device, the system comprising:
an adaptive input device including a plurality of depressible buttons, one or more depressible buttons having a dynamically updateable display region configured to display graphical images and/or a touch-sensitive input region for detecting touch input; and
a computing device operatively coupled to the adaptive input device, the computing device having identity data including a device identifier and a content identifier, where the computing device includes an identity module to:
receive a user identifier and a role identifier via the adaptive input device;
receive an identity data query at the computing device from a server; and
send the identity data, including the user identifier, role identifier, device identifier and content identifier to a server, responsive to the identity data query;
and where the computing device further includes a configuration module to:
receive profile data including device-specific settings, application-specific settings, and user-specific settings at the computing device, the profile data being based on the identity data; and
send a configuration message to the adaptive input device to update the visual appearance of the display region, the configuration message being based on the profile data.

18. The system of claim 17, where the configuration message includes instructions to change a functionality of one or more depressible buttons.

19. The system of claim 17, where the computing device further includes code to receive an authorization identifier via the adaptive input device, and to authenticate the user identifier based on the authorization identifier.

20. The system of claim 17, where profile data includes one or more of peripheral device preferences, input method preferences, a security preference, a sharing preference, a performance preference, a graphical layout preference, and a language preference.
